(19) United States
(12) Patent Application Publication
(10) Pub. No.: US 2006/0209462 A1
(43) Pub. Date: Sep. 21, 2006

(54) Head suspension assembly contributing to constant flying height of head slider

(75) Inventors: Osamu Kajitani, Kawasaki (JP); Masato Osawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/189,951

(22) Filed: Jul. 26, 2005

(30) Foreign Application Priority Data
Mar. 17, 2005 (JP) 2005-077045

(51) Int. Cl. G11B 5/60

(52) U.S. Cl. 360/234.6

(57) ABSTRACT

An adhesive layer is interposed between a head slider and a support member for fixing the head slider to the support member. A deformation body is interposed between the head slider and the support member. The deformation body has a coefficient of thermal expansion larger than that of the adhesive layer. The deformation body expands in response to rise in temperature. An internal force is induced in the head slider so as to distance the head slider away from the support member. Since the adhesive layer serves to fix the head slider to the support member, the internal force is transformed into stress in the head slider. The thermal expansion induces stress in the head slider in response to the rise in temperature. The stresses are balanced with each other, so that the head slider is prevented from deformation.

### BACKGROUND OF THE INVENTION

1. Field of the Invention

The present invention relates to a head suspension assembly incorporated within a disk drive such as a hard disk drive (HDD), for example.

2. Description of the Prior Art

Ahead suspension assembly is usually incorporated within a hard disk drive. A flexure is fixed on the front end of a head suspension in the head suspension assembly. A flying head slider is fixed on the surface of the flexure. An adhesive layer is interposed between the flexure and the flying head slider so as to fix the flying head slider to the flexure.

The flying head slider is designed to oppose the medium-opposed or bottom surface to a magnetic recording disk. The bottom surface is in general formed in a convex shape having a smaller curvature. The bottom surface swells most at the intermediate position between the upstream or leading end and the downstream or trailing end. When the magnetic recording disk rotates, the flying head slider is allowed to receive airflow generated along the rotating magnetic recording disk. The airflow serves to generate positive pressure or a lift and negative pressure on the flying head slider. The flying head slider is thus allowed to keep flying above the surface of the magnetic recording disk during the rotation of the magnetic recording disk based on the balance established between the urging force of the head suspension and the combination of the lift and the negative pressure.

Stress is induced in the flying head slider based on thermal expansion in response to increase in the temperature thereof. This stress causes the flying head slider to deform. The bottom surface suffers from variation in the curvature. This variation in the curvature causes variation in the lift on the flying head slider. The balance thus breaks between the lift and the negative pressure. The flying height of the flying head slider correspondingly varies. An electromagnetic transducer mounted on the flying head slider sometimes cannot effect read or write operation with a higher accuracy because of the variation in the flying height.

### SUMMARY OF THE INVENTION

It is accordingly an object of the present invention to provide a recording disk drive capable of preventing the deformation of a head slider. It is an object of the present invention to provide a head suspension assembly capable of effectively contributing to establishment of the mentioned recording disk drive.

According to a first aspect of the present invention, there is provided a recording disk drive comprising: a recording disk; ahead slider opposing a medium-opposed surface to the recording disk; a support member supporting the head slider; an adhesive layer interposed between the head slider and the support member for fixing the head slider to the support member; and a deformation body interposed between the head slider and the support member, said deformation body having a coefficient of thermal expansion larger than that of the adhesive layer.

The recording disk drive allows the deformation body to expand in response to rise in temperature. In this case, an internal force is induced in the head slider so as to distance the head slider away from the support member. Since the adhesive layer serves to fix the head slider to the support member, the internal force is transformed into stress in the head slider. On the other hand, the thermal expansion induces stress in the head slider in response to the rise in temperature. The stresses are balanced with each other, so that the head slider is prevented from deformation. Avoidance of the deformation in the head slider serves to maintain the head slider at a constant flying height.

A specific head suspension assembly may be provided to realize the aforementioned recording disk drive. The head suspension assembly comprises: a head slider; a support member supporting the head slider; an adhesive layer interposed between the head slider and the support member for fixing the head slider to the support member; and a deformation body interposed between the head slider and the support member, said deformation body having a coefficient of thermal expansion larger than that of the adhesive layer.

According to a second aspect of the present invention, there is provided a recording disk drive comprising: a recording disk; a head slider opposing a medium-opposed surface to the recording disk; a support member supporting the head slider; an adhesive layer interposed between the head slider and the support member for fixing the head slider to the support member; a deformation body interposed between the head slider and the support member; an exoergic body located on the surface of the support member so as to touch the deformation body; and a controller designed to control the temperature of the exoergic body.

The recording disk drive allows the exoergic body to promote the thermal expansion of the deformation body based on the heat from the exoergic body. The controller serves to control the temperature of the exoergic body. The thermal expansion of the deformation body can be controlled irrespective of the kind of the material applied to the deformation body. The thermal expansion of the deformation body can also be controlled depending on the thermal expansion of the head slider. The head slider is prevented from deformation with a higher accuracy. The head slider is surely allowed to enjoy a constant flying height with a higher accuracy.

The recording disk drive may further comprise a temperature sensor designed to supply the controller with a temperature information signal specifying the temperature detected at the temperature sensor. The temperature sensor detects the temperature inside the enclosure of the recording disk drive. The controller receives the temperature information signal specifying the detected temperature. The controller is thus allowed to control the temperature of the exoergic body based on the temperature information signal. The thermal expansion of the deformation body can be controlled with a further higher accuracy.

The recording disk drive may further comprise an atmospheric pressure sensor designed to supply the controller with an atmospheric pressure information signal specifying the atmospheric pressure detected at the atmospheric pressure sensor. The atmospheric pressure sensor detects the atmospheric pressure inside the enclosure of the recording disk drive. The controller receives the atmospheric pressure information signal specifying the detected atmospheric pressure. The controller is thus allowed to control the temperature of the exoergic body based on the atmospheric pressure information signal.

A specific head suspension assembly may be provided to realize the aforementioned recording disk drive. The head suspension assembly comprises: a head slider; a support member supporting the head slider; an adhesive layer interposed between the head slider and the support member for fixing the head slider to the support member; a deformation body interposed between the head slider and the support member; an exoergic body located on the surface of the support member so as to touch the deformation body.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a recording disk drive according to an embodiment of the present invention;

FIG. 2 is a perspective view schematically illustrating the structure of a head suspension assembly according to an embodiment of the present invention;

FIG. 3 is an enlarged partial plan view of the head suspension assembly for schematically illustrating the structure around a flying head slider;

FIG. 4 is an enlarged partial sectional view taken along the line 4-4 in FIG. 3;

FIG. 5 is a graph showing the relationship between the flying height of the flying head slider and the temperature in a conventional head suspension assembly on the assumption that the convex shape of the bottom surface is maintained at a constant curvature irrespective of variation in the temperature;

FIG. 6 is a graph showing the relationship between the curvature of the bottom surface of the flying head slider and the temperature in the conventional head suspension assembly;

FIG. 7 is a graph showing the relationship between the flying height of the flying head slider and the curvature of the bottom surface in the conventional head suspension assembly;

FIG. 8 is a graph showing the relationship between the flying height of the flying head slider and the temperature in the conventional head suspension assembly;

FIG. 9 is an enlarged partial plan view of ahead suspension assembly for schematically illustrating the structure around the flying head slider according to another example;

FIG. 10 is an enlarged partial sectional view taken along the line 10-10 in FIG. 9; and

FIG. 11 is an enlarged partial sectional view of a head suspension assembly for schematically illustrating the structure around the flying head slider according to a modified example.

### DESCRIPTION OF THE PREFERRED EMBODIMENTS

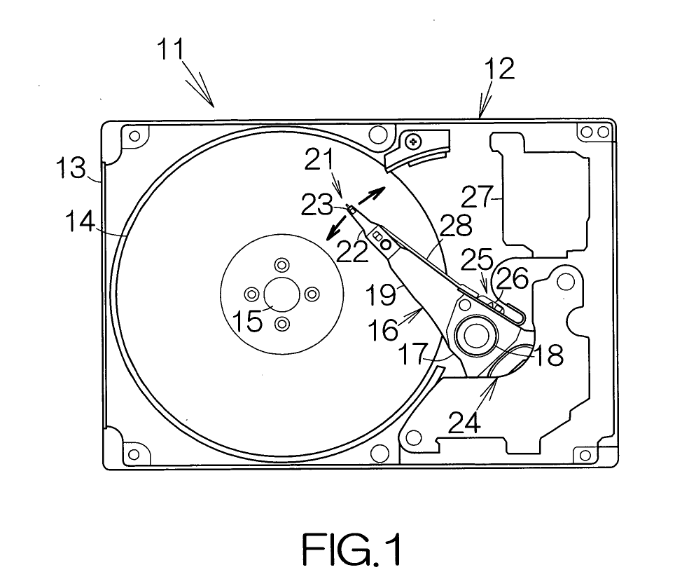

FIG. 1 schematically illustrates the inner structure of a hard disk drive, HDD, 11 as an example of a recording medium drive or storage device. The hard disk drive 11 includes a box-shaped enclosure 12. The enclosure 12 includes a boxed-shaped base 13 defining an inner space of a flat parallelepiped, for example. The base 13 may be made of a metallic material such as aluminum, for example. Molding process may be employed to form the base 13. A cover, not shown, is coupled to the base 13. The cover closes the opening of the inner space with in the base 13. Pressing process may be employed to form the cover out of a plate material, for example.

A printed circuit board, not shown, is fixed on the outside of the base 13. LSI chips, connectors, and the like, are mounted on the printed circuit board. The LSI chips may include a controller or central processing unit, CPU, a hard disk controller, HDC, and the like. The central processing unit and the hard disk controller serve to control the operations of the hard disk drive 11. The connector is designed to receive cables for control signals, a cable for power supply, and the like. The cables for control signals extend from a main board incorporated within a host computer, for example. The central processing unit and the hard disk controller operate in response to the supply of electric power through the cable.

At least one magnetic recording disk 14 as a recording medium is incorporated within the inner space of the base 13. The magnetic recording disk or disks 14 is mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A head actuator 16 is also incorporated within the inner space of the base 13. The head actuator 16 includes an actuator block 17. The actuator block 17 is supported on a vertical support shaft 18 for relative rotation. Actuator arms 19 are defined in the actuator block 17. The actuator arms 19 are designed to extend in a horizontal direction from the vertical support shaft 18. The actuator block 18 may be made of aluminum, for example. Extrusion molding process may be employed to form the actuator block 17.

A head suspension assembly 21 is attached to the corresponding tip end of the individual actuator arm 19 so as to further extend forward from the actuator arm 19. The head suspension assembly 21 includes a head suspension 22. The head suspension 22 extends forward from the front end of the actuator arm 19. An urging force of a predetermined intensity acts on the front end of the head suspension 22 in a direction toward the surface of the magnetic recording disk 14.

A flying head slider 23 is fixed on the front end of the head suspension 22. The flying head slider 23 is designed to oppose a medium-opposed surface or bottom surface to the surface of the magnetic recording disk 14. An electromagnetic transducer, not shown, is mounted on the flying head slider 23. The electromagnetic transducer may include a write element and a read element. The write element may include a thin film magnetic head designed to write magnetic bit data into the magnetic recording disk 14 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example.

When the magnetic recording disk 14 rotates, the flying head slider 23 is allowed to receive airflow generated along the rotating magnetic recording disk 14. The airflow serves to generate positive pressure or a lift and negative pressure on the flying head slider 23. The flying head slider 23 is thus allowed to keep flying above the surface of the magnetic recording disk 14 during the rotation of the magnetic recording disk 14 at a higher stability established by the balance between the urging force of the head suspension 22 and the combination of the lift and the negative pressure.

A voice coil motor, VCM, 24 is coupled to the actuator block 17. The voice coil motor 24 serves to drive the actuator block 17 around the vertical support shaft 18. The rotation of the actuator block 17 allows the actuator arms 19 and the head suspension assemblies 21 to swing. When the actuator arm 19 swings around the vertical support shaft 18 during the flight of the flying head slider 23, the flying head slider 23 is allowed to move along the radial direction of the magnetic recording disk 14. The electromagnetic transducer on the flying head slider 23 can thus be positioned right above a target recording track on the magnetic recording disk 14.

A printed circuit board or flexible printed circuit board (FPC) unit 25 is located on the actuator block 17. A head IC (integrated circuit) or preamplifier IC 26 is incorporated in the flexible printed circuit board unit 25. The preamplifier IC 26 is designed to supply the read element with a sensing current when magnetic bit data is to be read. The preamplifier IC 26 is also designed to supply the write element with a writing current when magnetic bit data is to be written. A small-sized circuit board 27 is located within the inner space of the base 13. The circuit board 27 and the aforementioned printed circuit board are designed to supply the preamplifier IC 26 in the flexible printed circuit board unit 25 with the sensing current and the writing current.

A flexible printed circuit board, FPC, 28 is utilized to supply the preamplifier IC 26 with the sensing current and the writing current. The flexible printed circuit board 28 is located on the individual head suspension assembly 21. The flexible printed circuit board 28 includes a metallic thin film such as a stainless steel thin film. An insulating layer, an electrically-conductive layer and an insulating protection layer are in this sequence formed over the metallic thin film, for example. The electrically-conductive layer provide swiring patterns, not shown, extending over the flexible printed circuit board 28. The electrically-conductive layer may be made of an electrically-conductive material such as copper, for example. The insulating layer and the protection layer may be made of a resin material such as polyimide resin, for example.

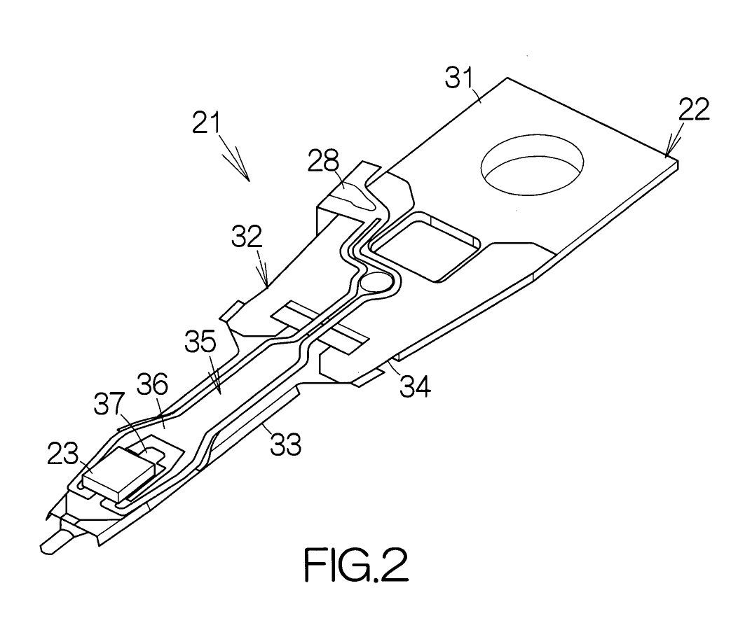

As shown in FIG. 2, the head suspension assembly 21 includes a base material or metallic plate 31 made of a metal such as a stainless steel. A load beam 32 extends forward from the metallic plate 31. Caulking process may be employed to fix the metallic plate 31 on the actuate or arm 19. The load beam 32 defines a rigid portion 33 and an elastic bend section 34. The rigid portion 33 is located off the metallic plate 31 at a predetermined distance. The elastic bend section 34 is defined between the rigid portion 33 and the metallic plate 31.

A support member or flexure 35 is attached to the front end of the load beam 32. The flexure 35 is made of a metal such as a stainless steel, for example. The flexure 35 includes a fixation plate 36 fixed to the surface of the load beam 32 and a support plate 37 receiving the flying head slider 23 on its surface. A so-called gimbal spring is utilized to connect the support plate 37 to the fixation plate 36. When the flexure 35 is attached to the load beam 32, the back surface of the support plate 37 is received on a domed protrusion formed on the front surface of the load beam 32. The fixation plate 36, the support plate 37 and the gimbal spring may be made of a single plate-shaped spring material.

The elastic bend section 34 is designed to exhibit elasticity or flexural force of a predetermined intensity in the load beam 32. This flexural force serves to urge the front end of the rigid portion 33 toward the surface of the magnetic recording disk 14. The urging force acts on the flying head slider 23 from the back of the support plate 37 through the domed protrusion. The flying head slider 23 is allowed to change its attitude based on the distribution of a lift under the influence of airflow. The domed protrusion allows changes in the attitude of the flying head slider 23 or the support plate 37.

One end of the aforementioned flexible printed circuit board 28 is fixed to the flexure 35. Wiring patterns on the flexible printed circuit board 28 are connected to the flying head slider 23. Adhesive may be employed to fix the flexible printed circuit board 28 on the load beam 32 or the flexure 35, for example. The flexible printed circuit board 28 extends backward along the side of the actuator arm 19 from the load beam 32. The other end of the flexible printed circuit board 28 is connected to the aforementioned flexible printed circuit board unit 25. The wiring patterns on the flexible printed circuit board 28 are connected to wiring patterns, not shown, on the flexible printed circuit board unit 25. The flying head slider 23 is in this manner electrically connected to the flexible printed circuit board unit 25.

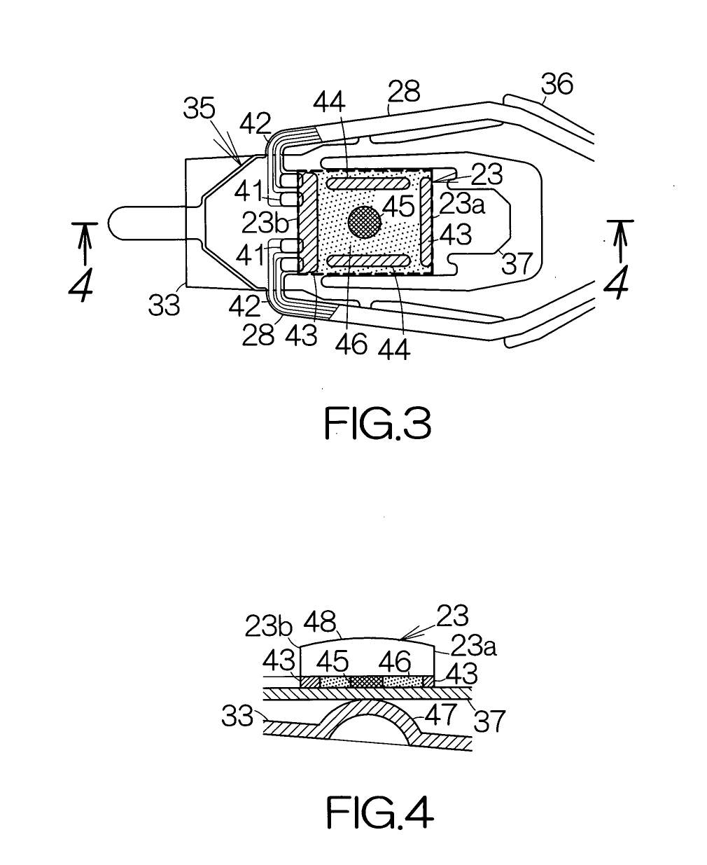

As shown in FIG. 3, the flying head slider 23 is electrically connected to the wiring patterns 42 on the flexible printed circuit board 28 through electrically-conductive pads 41 on the flexible printed circuit board 28. The flying head slider 23 is received on a pair of first setting 43, 43 extending in parallel with each other and a pair of second setting 44, 44 extending in parallel with each other. The first settings 43, 43 extend along the inflow or leading end 23a and the outflow or trailing end of the flying head slider 23, respectively. The second settings 44, 44 extend along the sides of the flying head slider 23. The first and second settings 43, 44 may be made of a resin material such as polyimide resin, for example.

A deformation body 45 is interposed between the flying head slider 23 and the support plate 37. The deformation body 45 is fixed to the surface of the support plate 37. The deformation body 45 may be made of a disk-shaped metallic material. The deformation body 45 is designed to have a predetermined coefficient of thermal expansion. The deformation body 45 is located in a space between the first settings 43, 43 and between the second settings 44, 44. The center of the deformation body 45 may be located at the intersection between the diagonals established on the top surface of the flying head slider 23, for example.

An adhesive layer 46 is interposed between the flying head slider 23 and the support plate 37. The adhesive layer 46 fills up the space defined between the flying head slider 23 and the support plate 37 around the first and second settings 43, 44 and the deformation body 45. The adhesive layer 46 serves to stably fix the flying head slider 23 to the support plate 37. Here, the coefficient of thermal expansion of the deformation body 45 is set larger than that of the adhesive layer 46.

As shown in FIG. 4, the back surface of the support plate 37 is received on the domed protrusion or so-called dimple 47 formed on the front surface of the rigid portion 33 of the load beam 32. As mentioned above, the domed protrusion 47 allows change in the attitude of the flying head slider 23 or the support plate 37. Here, the center of the domed protrusion 47 is aligned with the center of the deformation body 45. The deformation body 45 is in this manner interposed between the flying head slider 23 and the domed protrusion 47.

The bottom surface 48 of the flying head slider 23 is formed in a convex shape having a smaller curvature. The bottom surface 48 swells most at the intermediate position between the inflow end 23a and the outflow end 23b, for example. Here, the flying head slider 23 includes a slider body made of Al₂O₃—TiC and a protection film made of Al₂O₃. The protection film is coupled to the outflow end of the slider body so as to contain the electromagnetic transducer.

Now, assume that temperature rises in the hard disk drive 11. An internal force is induced in the flying head slider 23 so as to reduce the curvature of the convex shape in response to the rise in temperature. The internal force acts to cause the flying head slider 23 to get closer to the support plate 37. An internal force is likewise induced in the deformation body 45 so as to cause the thermal expansion of the deformation body 45 in response to the rise in temperature. Since the deformation body 45 is received on the domed protrusion 47 through the support member 37, the internal force of the deformation body 45 acts to cause the flying head slider 23 to get distanced from the support plate 37. The internal force is transformed into stress in the flying head slider 23 and the deformation body 45. The stress in the deformation body 45 is thus balanced with the stress in the flying head slider 23. This balance of the stress serves to prevent the flying head slider 23 from deformation. The curvature of the convex shape can thus be maintained. It is possible to reliably suppress variation in the flying height of the flying head slider 23. The electromagnetic transducer mounted on the flying head slider 23 is allowed to write magnetic bit data into the magnetic recording disk 14 with a higher accuracy. The electromagnetic transducer is likewise allowed to read magnetic bit data out of the magnetic recording disk 14 with a higher accuracy. Any material may be selected for the deformation body 45 depending on the magnitude of the internal force induced in the flying head slider 23 in response to rise in temperature.

In general, the flying head slider suffers from deformation due to thermal expansion. This deformation causes a reduction in the curvature of the bottom surface. This reduction in the curvature leads to a reduced flying height of the flying head slider. The electromagnetic transducer tends to suffer from a failure in the write and read operations.

The inventors have observed the variation in the flying height of the flying head slider. The inventors prepared a conventional head suspension assembly. The deformation body 45 is omitted from the conventional head suspension assembly. The other structures were set identical to those of the aforementioned head suspension assembly 21. The relationship was observed between the deformation of the flying head slider and the temperature as well as between the flying height and the temperature.

The inventors have first observed the relationship between the temperature and the flying height based on simulation. Here, the flying height corresponded to the minimum space between the bottom surface of the flying head slider and the magnetic recording disk. It was assumed that no change of shape was induced at the convex shape of the bottom surface in the flying head slider. As shown in FIG. 5, it has been confirmed that change in the temperature causes variation in the flying height ΔFH of the flying head slider. A rise in the temperature serves to cause a reduction in the flying height ΔFH. Change in the property of air in response to change in the temperature is supposed to induce change in the flying height ΔFH.

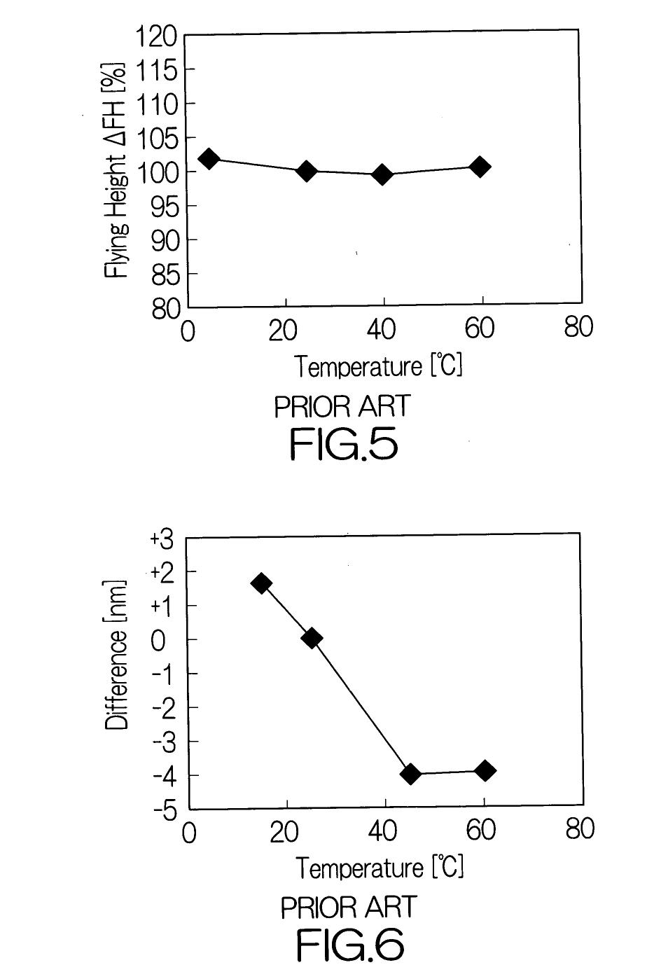

Next, the inventors have observed the relationship between the temperature and the deformation based on simulation. Here, the amount of deformation reflected the magnitude of the curvature of the bottom surface. Specifically, the curvature was calculated based on the difference between the maximum and minimum distances. The maximum and minimum distances were measured between the bottom surface and the support plate. As shown in FIG. 6, the inventors have confirmed that the difference varies in the flying head slider in response to change in the temperature. The difference took negative values in response to rise in the temperature. The curvature of the convex shape was reduced in response to rise in the temperature.

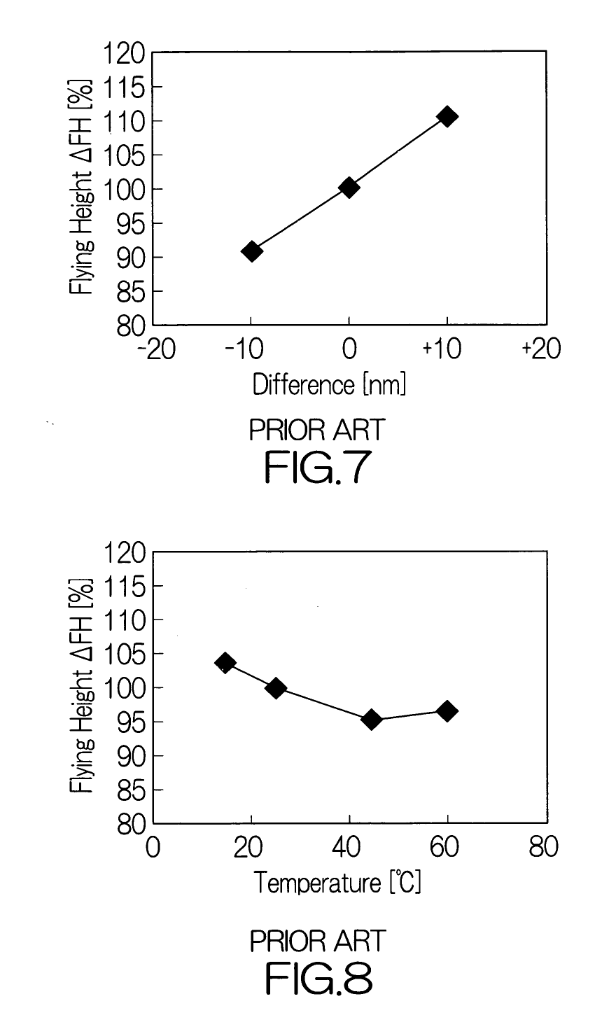

Next, the inventors have observed the relationship between the deformation and the flying height based on simulation. As shown in FIG. 7, the inventors have confirmed that an increased curvature leads to an increased flying height ΔFH of the flying head slider. A decreased curvature causes a reduction in the flying height. The inventors have derived the relationship between the temperature and the flying height ΔFH based on the above-described observation. As shown in FIG. 8, the conventional flying head slider suffers from a reduced flying height in response to rise in the temperature.

As shown in FIG. 9, an exoergic body 51 may additionally be located on the surface of the support plate 37. The exoergic body 51 is contacted with the deformation body 45. The exoergic body 51 may be made of an electrically-conductive metallic material, for example. Wiring patterns 52 on the flexible printed circuit board 28 are connected to the exoergic body 51. The current supplied from the circuit board 27 and the aforementioned printed circuit board circulates through the wiring patterns 52. The current is in this manner supplied to the exoergic body 51. The exoergic body 51 is designed to get heated in response to the supply of the current. The heat of the exoergic body 51 is transmitted to the deformation body 45.

The hard disk drive 11 includes the central processing unit, CPU, 53 as mentioned above. A temperature sensor 54 and an atmospheric pressure sensor 55 are connected to the central processing unit 53. The sensors 54, 55 are mounted on the circuit board 27, for example. The temperature sensor 54 detects the temperature inside the enclosure 12 of the hard disk drive 11. The temperature sensor 54 is designed to supply the central processing unit 53 with a temperature information signal specifying the detected temperature. The atmospheric pressure sensor 55 detects the atmospheric pressure inside the enclosure 12 of the hard disk drive 11. The atmospheric pressure sensor 55 is designed to supply the central processing unit 53 with an atmospheric pressure information signal specifying the atmospheric pressure specifying the detected atmospheric pressure.

The central processing unit 53 controls the quantity of the current supplied to the exoergic body 51 based on the supplied temperature information signal and the supplied atmospheric pressure information signal. The temperature changes in the exoergic body 51 in response to increase or decrease of the current. Accordingly, the temperature of the exoergic body 51 can be controlled based on the control on the quantity of the supplied current. The central processing unit 53 executes software programs stored in a non-volatile memory, not shown, for example. The relationship is defined between the quantity of the current and the temperature based on the kind of the material of the exoergic body 51.

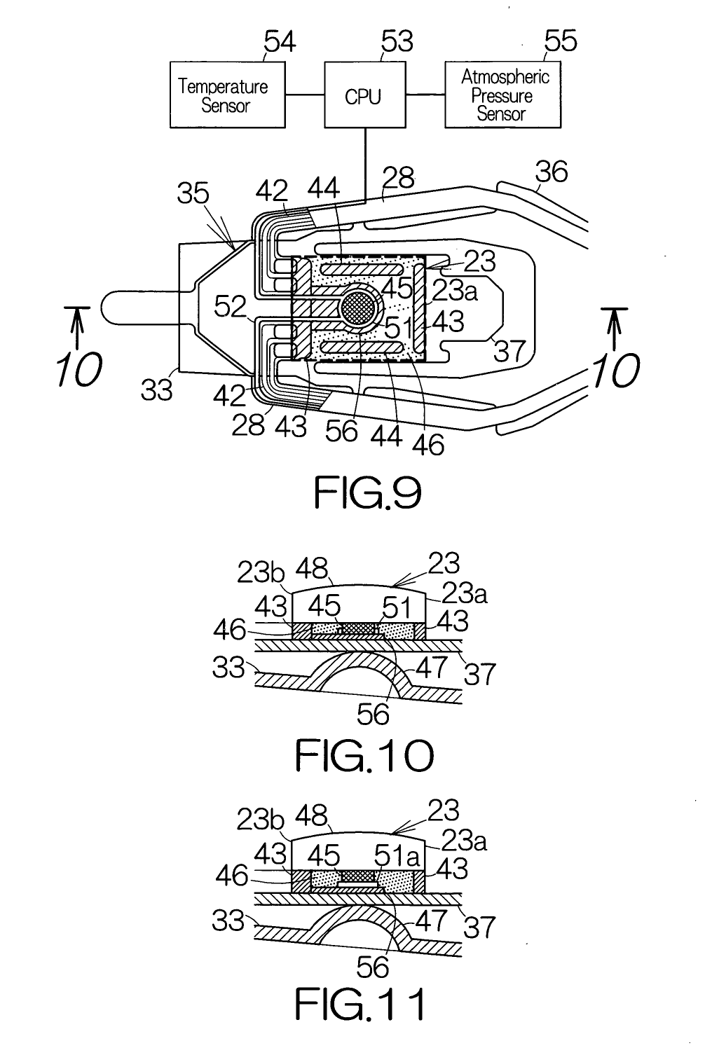

Referring also to FIG. 10, the exoergic body 51 may surround the deformation body 45, for example. The exoergic body 51 may be formed in an annular shape, for example. A third setting 56 may be employed to receive the exoergic body 51 and the deformation body 45 on the support plate 37. The third setting 56 may be made of a resin material such as polyimide resin, for example. The third setting 56 also receives the wiring patterns 52. Like reference numerals are attached to structure and components equivalent to those of the aforementioned embodiment.

The hard disk drive 11 allows the transmission of heat from the exoergic body 51 to the deformation body 45. The central processing unit 53 controls the temperature of the exoergic body 51. Accordingly, the thermal expansion of the deformation body 45 can be controlled with a higher accuracy. Moreover, the exoergic body 51 serves to promote the thermal expansion of the deformation body 45.

In addition, the temperature sensor 54 supplies the central processing unit 53 with the temperature information signal. The central processing unit 53 controls the quantity of the current supplied to the exoergic body 51 based on the temperature information signal. The temperature of the exoergic body 51 can in this manner be adjusted. The thermal expansion of the deformation body 45 can be controlled with a further higher accuracy. The convex shape of the bottom surface can be maintained at a constant curvature. The flying head slider 23 can be maintained at a constant flying height.

The central processing unit 53 also receives the atmospheric pressure information signal from the atmospheric pressure sensor 55. The central processing unit 53 is allowed to control the quantity of the current supplied to the exoergic body 51 based on the atmospheric pressure information signal. In general, reduction in the atmospheric pressure induces increase in the flying height even without variation in the curvature of the bottom surface 48. Increase in the supplied current in response to reduction in the atmospheric pressure leads to a constant flying height of the flying had slider 23.

Otherwise, the exoergic body 51a may uniformly receive the entire bottom surface of the deformation body 45, as shown in FIG. 11. The exoergic body 51a may be received on the third setting 56 in the aforementioned manner. The exoergic body 51a is allowed to touch the deformation body 45 over a larger contact area as compared with the aforementioned exoergic body 51. The heat is efficiently transmitted to the exoergic body 51a to the deformation body 45 in a shorter time period. The thermal expansion of the deformation body 45 can be realized in a shorter time period.

What is claimed is:

1. A disk drive comprising:
a disk;
a head slider opposing a medium-opposed surface to the disk;
a support member supporting the head slider;
an adhesive layer interposed between the head slider and the support member for fixing the head slider to the support member; and
a deformation body interposed between the head slider and the support member, said deformation body having a coefficient of thermal expansion larger than that of the adhesive layer.

2. A disk drive comprising:
a disk;
a head slider opposing a medium-opposed surface to the disk;
a support member supporting the head slider;
an adhesive layer interposed between the head slider and the support member for fixing the head slider to the support member;
a deformation body interposed between the head slider and the support member;
an exoergic body located on a surface of the support member so as to touch the deformation body; and
a controller designed to control temperature of the exoergic body.

3. The disk drive according to claim 2, further comprising a temperature sensor designed to supply the controller with a temperature information signal specifying temperature detected at the temperature sensor.

4. The disk drive according to claim 2, further comprising an atmospheric pressure sensor designed to supply the controller with an atmospheric pressure information signal specifying atmospheric pressure detected at the atmospheric pressure sensor.

5. A head suspension assembly comprising:
a head slider;
a support member supporting the head slider;
an adhesive layer interposed between the head slider and the support member for fixing the head slider to the support member; and
a deformation body interposed between the head slider and the support member, said deformation body having a coefficient of thermal expansion larger than that of the adhesive layer.

6. A head suspension assembly comprising:
a head slider;
a support member supporting the head slider;
an adhesive layer interposed between the head slider and the support member for fixing the head slider to the support member;
a deformation body interposed between the head slider and the support member;
an exoergic body located on a surface of the support member so as to touch the deformation body.
